(19) United States
(12) Patent Application Publication
(10) Pub. No.: US 2016/0183453 A1
(43) Pub. Date: Jun. 30, 2016

(54) Easy to Disassemble Hub and Spool Assembly of a Vegetation Trimmer

(71) Applicants: Ian Doane, Friendswood, TX (US); James Doane, Friendswood, TX (US)

(72) Inventors: Ian Doane, Friendswood, TX (US); James Doane, Friendswood, TX (US)

(21) Appl. No.: 14/588,161

(22) Filed: Dec. 31, 2014

(51) Int. Cl. A01D 34/416

(52) U.S. Cl. CPC A01D 34/4161

(57) ABSTRACT

A vegetation trimmer with a hub and spool assembly has a cutting filament wound around the spool. The free end of the filament extends through an aperture in the hub into the cutting plane. The hub and spool are rotated at a high rate to allow the filament to cut vegetation. The spool includes a plurality of arms which engage with arms on the hub. When the spool is acted upon, the arms on the spool disengage with the arms on the hub to permit relative rotation of the spool to the hub to feed additional filament into the cutting plane. An indexing feature is used to regulate the amount of additional cutting filament that is allowed to be fed into the cutting plane. The arms on the hub selectively engage with the arms on the spool to limit the axial movement between the spool and the hub. Quick removal is permitted when the spool is rotated relative to the hub and spool assembly, and the arms on the hub no longer limit the axial movement of the spool, and the spool is removed from the hub and spool assembly.

### FIELD OF THE INVENTION

The present invention relates generally to line trimmers for cutting vegetation and, more particularly, relates to spools having filament wound thereon which are installed to hubs of trimmers.

### BACKGROUND OF THE INVENTION

Vegetation trimmers are in common use for cutting vegetation in areas that are difficult to reach such as along houses, sidewalks, or around trees and bushes. Bump feed trimmers are convenient because when the cutting filament wears down, the user simply taps the vegetation trimmer against a hard surface to feed more cutting filament into the cutting plane. However, the user will eventually use all of the filament he initially wound around the spool, thus creating the need to wind more filament around the spool. Currently this is a difficult and tedious task because the bolt constraining the hub and spool assembly can become extremely tight as the vegetation trimmer is used, as well as the difficulty of tracking many small parts that are removed just to remove the spool.

Fixed line vegetation trimmers have been developed to address the problem of having to disassemble the hub and spool assembly. Fixed line vegetation trimmers do not have a complex hub and spool assembly. Fixed line trimmers have a hub which clamps a plurality of fixed length filaments. Fixed line vegetation trimmers are often configured such that the user simply inserts the filament into the clamp. The problem associated with this configuration is that the user has to stop more frequently to load new filament because he cannot simply tap the vegetation trimmer against a hard surface to feed more cutting filament into the cutting plane.

Easy feed vegetation trimmers have been developed to address the problem of having to disassemble the hub and spool assembly. The user inserts a length of filament through an aperture in the hub, through the center of the spool, and through the aperture in the hub directly opposite to the first aperture in the hub. The user then simply twists the spool to wind the line onto the spool. While using an easy feed vegetation trimmer, the user taps the vegetation trimmer against a hard surface to feed more filament into the cutting plane. The problem with this configuration is that it can still become difficult to disassemble if the need arises, and there are still many small parts that are removed.

The present invention addresses the issue of having to disassemble the hub and spool assembly when the need arises. All of the small parts are contained in the hub and spool assembly when the spool is removed. Arms on the hub selectively engage with arms on the spool to limit the axial movement of the spool, but still allow for normal operation of the vegetation trimmer. The spool is quickly removed when the user rotates the spool to one direction such that the arms on the hub no longer axially constrain the spool. Additionally, the user can be carrying an extra spool that has already been wound with filament. This would reduce the need for the user to wind new filament on the spool at the point in time he uses all the filament he initially wound around the spool. He simply inserts the extra spool into the hub and rotates it such that the arms on the hub engage with arms on the spool to limit the axial movement of the spool.

### SUMMARY OF THE INVENTION

A vegetation trimmer with a hub and spool is provided. The spool is rotationally locked relative to the hub in said first position and is allowed to rotate relative to the hub in said second position. At least one cutting filament is wound around the spool and extends radially outward into the cutting plane. Arms on the hub selectively engage with arms on the spool to limit the axial movement of the spool relative to the hub. The spool is quickly removed from the hub when the user rotates the spool relative to the hub such that the arms on the hub no longer limit the axial movement of the spool. Alternately, the spool can be quickly removed from the hub when the user provides a sufficient axial force to the spool in a direction away from the hub. Examples are shown in FIG. 6.

Preferably, arms on the hub engage with arms on the spool to axially constrain the spool to the hub in said first position. When the spool is acted upon, the spool moves axially toward the hub and arms on the hub no longer engage with arms on the spool to rotationally lock the spool relative to the hub. As the spool rotates relative to said hub in said second position, arms on the spool strike arms on the hub after a predetermined amount of relative rotation has been achieved. A biasing member biases the spool away from the hub and the spool enters into said first position. To remove the spool from the hub and spool assembly, the user rotates the spool relative to the hub in a direction opposite of the relative rotation that occurs in the second position to disengage arms on the hub from arms on the spool. Indicators such as arrows can be provided to remind the user which way to rotate the spool to achieve this effect. The biasing member will continue to bias the spool away from the hub to assist the user with quick removal.

Those skilled in the art will appreciate that the present invention can be expanded such that arms on the spool selectively engage with arms on other parts of the hub and spool assembly to limit the axial movement of the spool relative to the hub. This would allow for a wide range of designs that would allow a retrofit onto any existing vegetation trimmer. Examples of expansions of the current invention described above are shown in FIGS. 4 and 5. FIG. 4 illustrates that parts traditionally not included in a hub and spool assembly can be added to achieve the quick release effect the current invention provides. In FIG. 4, an insert is provided for easy attachment and removal of the spool from the hub and spool assembly. In FIG. 5, arms on the spool engage with arms on the shaft of the vegetation trimmer to allow for quick removal of the spool from the hub and spool assembly.

Alternately, the biasing member can be rigidly attached to the hub and spool assembly. A groove is provided in the spool to provide for a tight fit of the biasing member to the spool. The friction from the tight fit would be such that it contains the spool to the hub and spool assembly while the vegetation trimmer is being operated, but the friction would not be so great that the user cannot easily remove the spool by hand. This example of an alternate way of attaching the spool to the hub and spool assembly is shown in FIG. 6.

Arms on the hub and spool assembly can be made out of a material such that when a sufficient axial force is applied to the spool, arms on the spool deform the material to allow for axial movement of the arms on the spool through the axial positions normally limited by the arms on the hub and spool assembly. This is illustrated in FIG. 7.

An object of this invention is to create a hub and spool assembly such that the spool can be quickly removed from the hub and spool assembly. The amount of time spent refreshing the filament on the vegetation trimmer is significantly reduced, thus significantly reducing the amount of time required to cut an area of vegetation.

Another object of this invention is to create a hub and spool assembly such that when the filament is exhausted from the spool, the user does not have to wind new filament on the spool at that point in time. The user can carry a spool that has already been wound with filament and simply insert the new spool into the hub and spool assembly. This would allow the user to choose a more convenient time to wind the spool with cutting filament. One example would be a yard cutting service winding several spools with filament in between jobs instead of in the middle of trimming a yard.

Another object of this invention is to create a hub and spool assembly such that the spool can be positioned to axial positions other than those required for cutting vegetation and feeding additional cutting filament into the cutting plane. One example of an alternate implementation of the current invention (see FIG. 3) is to provide a hub and spool assembly such that when the spool is rotated in a direction relative to the hub and spool assembly, the arms on the hub and spool assembly disengage with the arms on the spool to permit axial movement to allow easy access to the filament wound around the spool, but a bolt would prevent the spool from being completely removed from the hub and spool assembly. This would allow the user easy access to the inner workings of the hub and spool assembly without needing to remove any parts.

Another object of this invention is to create alternatives for attaching the hub and spool assembly to the vegetation trimmer such that the hub and spool assembly can be removed and/or disassembled by hand.

The following US patents are relevant to the inner workings of string line trimmers: U.S. Pat. No. 4,047,299; U.S. Pat. No. 4,272,201; U.S. Pat. No. 4,524,515; U.S. Pat. No. 4,633,588; U.S. Pat. No. 4,656,739; U.S. Pat. No. 5,020,223; U.S. Pat. No. 5,339,526; U.S. Pat. No. 5,987,756; U.S. Pat. No. 6,094,823, U.S. Pat. No. 7,111,403, and U.S. Pat. No. 8,176,639.

### BRIEF DESCRIPTION OF THE DRAWINGS

FIG. 1 is an exploded isometric view of the hub and spool assembly;

FIG. 2 is a cutaway view of the hub outlining the various positions the arm on the spool can take when in first, second, or third positions;

FIG. 3 is a cutaway view of an alternate embodiment where an additional axial restraint is provided;

FIG. 4 is an exploded isometric view of an alternate embodiment where an insert is provided to allow for implementation of the present invention;

FIG. 5 is a cutaway view of an alternate embodiment where arms on the shaft engage with arms on the spool to limit axial movement of the spool;

FIG. 6 is a cutaway view of an alternate embodiment where the biasing member fits tightly in a groove in the spool to contain the spool to the hub and spool assembly;

FIG. 7 is a cutaway view of an alternate embodiment where the arms on the hub are made of a deformable material.

### DETAILED DESCRIPTION OF THE PREFERRED EMBODIMENT

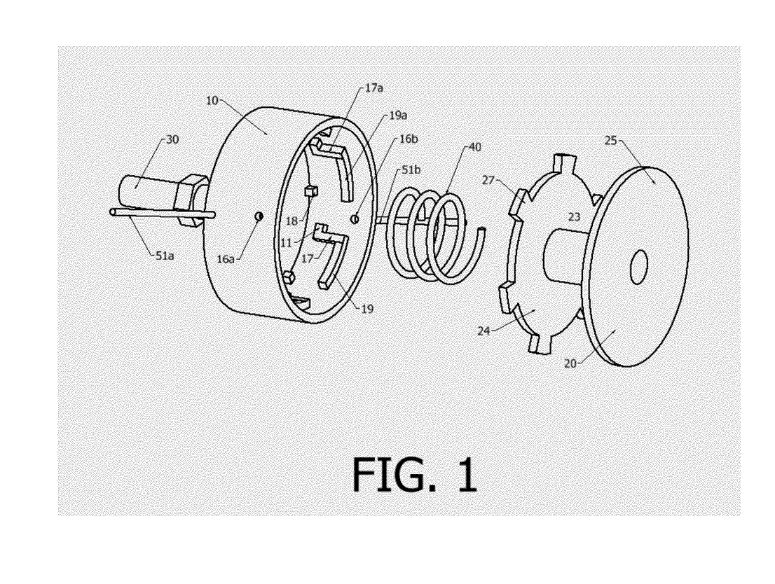

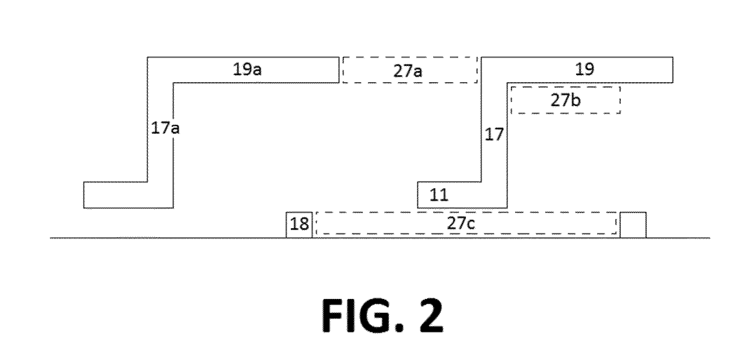

Referring to FIGS. 1 and 2, hub 10 is rotationally and axially locked to the shaft 30 of the vegetation trimmer. Filament 51 is wound around spool 20 in cavity 23. Cavity 23 is created by walls 24 and 25. When assembled, filament 51 extends through aperture 16 see FIG. 1. Region 27b in FIG. 2 is the location of tab 27 on spool 20 when the hub and spool assembly is in the first position. Biasing member 40 biases spool 20 axially away from hub 10. Tab 19 on hub 10 engages with tab 27 on spool 20 to limit the axial position of spool 20 relative to hub 10. Tab 17 on hub 10 engages with tab 27 on spool 20 to rotationally lock spool 20 relative to hub 10.

Based on the above description of FIGS. 1 and 2, spool 20 moves into the second position when spool 20 moves axially towards hub 10. Region 27c on FIG. 2 is the location of tab 27 on spool 20 when the hub and spool assembly is in the second position. Because spool 20 is rotating relative to hub 10, tab 27 on spool 20 will strike tab 18 on hub 10. Tab 11 axially limits spool 20 while spool 20 is rotating relative to hub 10. Tab 11 is optional because spool 20 will not move sufficiently in an axial direction away from hub 10 while spool 20 is in the second position to cause axial disengagement of spool 20 from hub 10. Biasing member 40 will move spool 20 axially away from hub 10. Arm 19a on hub 10 will engage with arm 27 on spool 20 when biasing member 40 moves spool 20 axially away from hub 10. Arm 27 on spool 20 will strike arm 17a on hub 10, which defines the end of the second position and returning to the first position.

Based on the above description of FIGS. 1 and 2, spool 20 is removed from the hub and spool assembly when spool 20 is rotated relative to hub 10 in a direction opposite to the relative rotation that occurs in said second position. Region 27a in FIG. 2 is the location of tab 27 on spool 20 when spool 20 is being removed from hub 10. Arm 19a on hub 10 is no longer in engagement with arm 27 on spool 20. Spool 20 is no longer axially limited relative to hub 10, and spool 20 is removed from the hub and spool assembly.

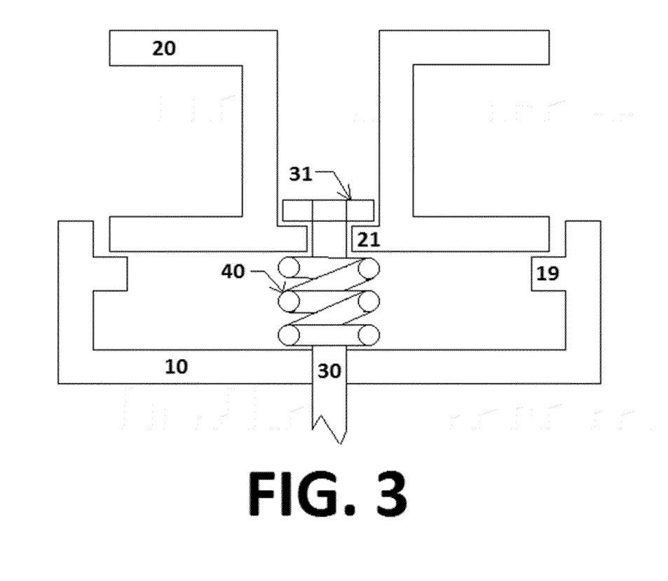

Based on the above description of FIGS. 1 and 2, and now referring to FIG. 3, bolt 31 threads into shaft 30. When spool 20 is rotated relative to hub 10 such that arm 19 on hub 10 is no longer in engagement with arm 27 on spool 20, spool 20 moves axially away from hub 10. Bolt 31 engages with disc 21 on spool 20 to limit the axial movement of spool 20.

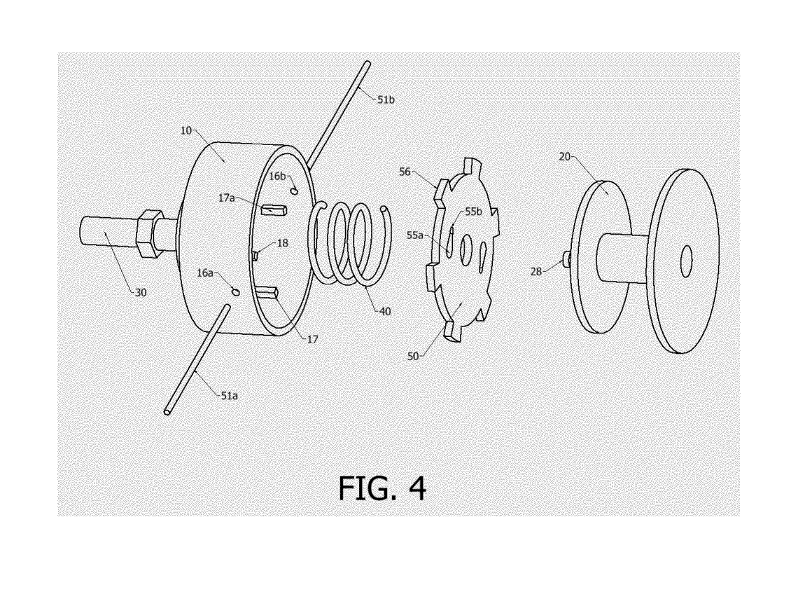

Referring now to FIG. 4, insert 50 is axially constrained to hub 10 by bolt 31. Tab 17 on hub 10 shoulders against tab 56 on insert 50 to rotationally lock insert 50 relative to hub 10 when insert 50 is in the first position. Pin 28 on spool 20 is inserted into aperture 55a on insert 50. Spool 20 is then rotated such that pin 28 on spool 20 is contained in aperture 55b on insert 50. Pin 28 on spool 20 shoulders against insert 50 to axially constrain spool 20 to hub 10. When spool 20 is acted upon, insert 50 moves axially inward relative to hub 10, and tab 17 on hub 10 disengages from tab 56 to allow rotation of insert 50 relative to hub 10 in the second position.

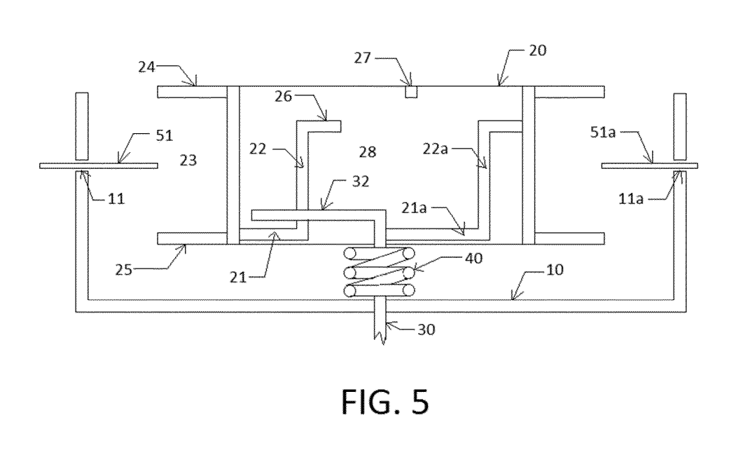

Referring now to FIG. 5, hub 10 is rotationally and axially locked to shaft 30. Filaments 51 and 51a are wound around spool 20 in cavity 23. Cavity 23 is created by walls 24 and 25. When assembled, filament 51 extends through aperture 11, and filament 51a extends through aperture 11a. Biasing member 40 biases spool 20 axially away from hub 10. Tab 21 on spool 20 engages with tab 32 on shaft 30 to limit the axial position of spool 20 relative to hub 10. Tab 22 on spool 20 engages with tab 32 on shaft 30 to rotationally lock spool 20 relative to hub 10. This defines the first position of spool 20.

Based on the above description of FIG. 5, spool 20 moves into the second position when spool 20 moves axially towards hub 10. Because spool 20 is rotating relative to hub 10, tab 32 on shaft 30 will strike tab 27 on spool 20. Tab 26 axially limits spool 20 while spool 20 is rotating relative to hub 10. Tab 26 is optional because spool 20 will not move sufficiently in an axial direction away from hub 10 while spool 20 is in the second position to cause axial disengagement of spool 20 from hub 10. Biasing member 40 will move spool 20 axially away from hub 10. Arm 21a on spool 20 will engage with arm 32 on shaft 30 when biasing member 40 moves spool 20 axially away from hub 10. Tab 32 on shaft 30 will strike arm 22a on spool 20, which defines the end of the second position and returning to the first position.

Based on the above description of FIG. 5, spool 20 is removed from the hub and spool assembly when spool 20 is rotated relative to hub 10 in a direction opposite to the relative rotation that occurs in said second position. Arm 32 on shaft 30 is no longer in engagement with tab 21 on spool 20. Spool 20 is no longer axially limited relative to hub 10, and spool 20 is removed from the hub and spool assembly. Those skilled in the art will recognize that the pattern of the tabs (21, 21a, 22, 22a, 26, and 27) on spool 20 as described in FIG. 5 and the pattern of the tabs (11, 17, 17a, 18, 19, and 19a) on hub 10 as described in FIGS. 1 and 2 are the exact same and can be applied to other components of the hub and spool assembly.

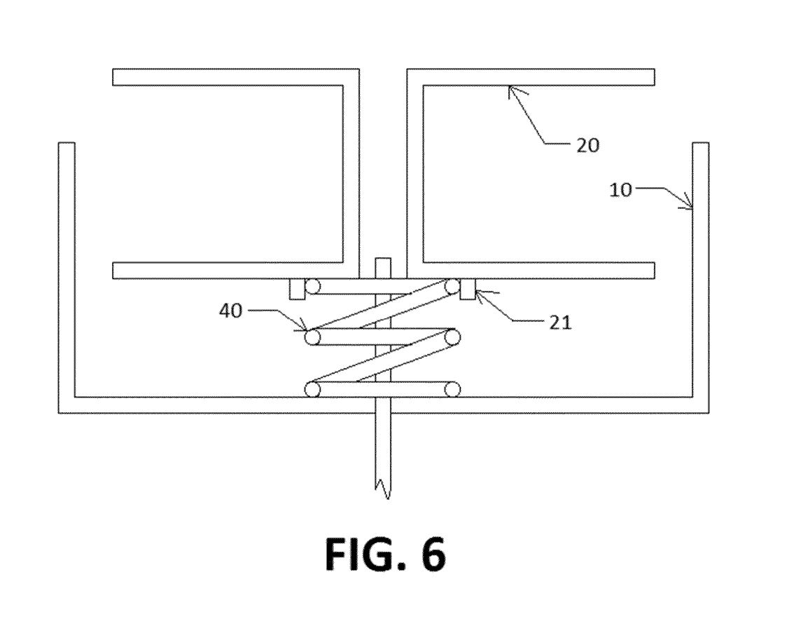

Referring now to FIG. 6, biasing member 40 is firmly attached to hub 10 and the opposite end of biasing member 40 is inserted into groove 21 on spool 20. The tight fit of groove 21 on spool 20 to biasing member 40 prevents axial movement of spool 20 relative to hub 10. When a sufficient axial force is applied to spool 20, biasing member 40 is removed from groove 21 on spool 20 and spool 20 is removed from the hub and spool assembly.

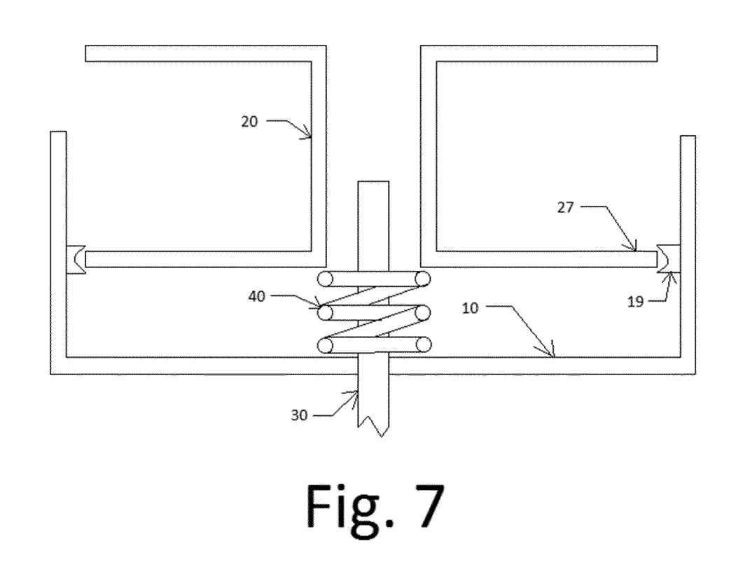

Based on the above description of FIGS. 1 and 2 and now referring to FIG. 7, arm 19 on hub 10 is made of a deformable material. When a sufficient axial force is applied to spool 20, arm 27 on spool 20 deforms arm 19 on hub 10 to create axial access for arm 27 on spool 20. After arm 27 on spool 20 has passed through the axial position occupied by arm 19 on hub 10, arm 19 on hub 10 returns to its original shape. Referring to FIG. 3, additional axial restraints 31 can be added to this alternate embodiment to create a plurality of axial positions of spool 20 relative to hub 10.

We claim:

1. A vegetation trimmer, comprising:
a hub and spool assembly having arms engaging with a spool to regulate axial movement of said spool relative to said hub and spool assembly.

2. The vegetation trimmer of claim 1, wherein:
said arms on said hub and spool assembly selectively engage with said spool to regulate said axial movement of said spool relative to said hub and spool assembly.

3. The vegetation trimmer of claim 1, wherein:
said axial movement of said spool is regulated by said arms on said spool and said arms on said hub.

4. The vegetation trimmer of claim 1, wherein:
said arms on said hub and spool assembly limit said spool to a plurality of axial positions relative to said hub and spool assembly.

5. The vegetation trimmer of claim 1, wherein:
said spool is removed from said hub and spool assembly when said arms on said hub and spool assembly do not regulate said axial movement of said spool relative to said hub and spool assembly.

6. The vegetation trimmer of claim 1, wherein:
when said spool is rotated relative to said hub and spool assembly, said arms on said hub and spool assembly disengage from said spool, and said spool is removed from said hub and spool assembly.

7. The vegetation trimmer of claim 1, wherein:
said arms on said hub and spool assembly limit said spool to a first axial position, where said spool is rotationally locked relative to said hub;
said arms on said hub and spool assembly limit said spool to a second axial position, where said spool rotates relative to said hub;
said arms on said hub limit said spool to a third axial position, where filament wound around said spool is accessible.

8. The vegetation trimmer of claim 1, wherein:
said spool is removed from said hub and spool assembly when rotated relative to said hub and spool assembly.

9. The vegetation trimmer of claim 1, wherein:
a biasing member biases said spool in an axial direction away from said hub and spool assembly.

10. The vegetation trimmer of claim 1, wherein:
said biasing member biases said spool in said axial direction away from said hub to assist with said removal of said spool from said hub and spool assembly.

11. The vegetation trimmer of claim 1, wherein:
said arms on said hub and spool assembly regulate said spool to a discrete number of axial positions in a direction axially away from said first position.

12. The vegetation trimmer of claim 1, wherein:
said arms on said hub and spool assembly are z-shaped.

13. The vegetation trimmer of claim 1, wherein:
indicators are provided on the hub and spool assembly to indicate the direction of said relative rotation of said spool to said hub to disengage said arms on said hub and spool assembly and said arms on said spool.

14. A vegetation trimmer comprising:
a hub and spool assembly having at least one filament extending from an opening in said hub for cutting vegetation when rotated;
said arms on said hub and spool assembly selectively engage with said arms on said spool to regulate said spool to at least one axial position;
said arms on said hub and spool assembly disengage with said arms on said spool when a sufficient axial force is applied to said spool.

15. The vegetation trimmer of claim 14, wherein:
said biasing member biases said spool axially away from said hub and spool position in said first position, where said spool is rotationally locked to said hub for cutting of vegetation;
arms on said hub and spool assembly oppose said bias from said biasing member to prevent travel to other axial positions located to an axial direction away from said hub and spool assembly while said spool is in said first position.

16. The vegetation trimmer of claim 14, wherein:
a secondary axial restraint regulates said spool to at least one axial position upon disengagement of said arms on said hub and spool assembly and said arms on said spool.

17. The vegetation trimmer of claim 14, wherein:
said arms on said spool are made of a deformable material.

18. The vegetation trimmer of claim 14, wherein:
said arms on said hub and spool assembly are made of a deformable material.

19. A method of axially constraining a spool to a hub and spool assembly comprising:
axially moving said spool towards said hub and spool assembly;
rotating said spool relative to said hub and spool assembly.

20. The method of claim 19, comprising:
aligning said arms on said spool and said arms on said hub and spool assembly such that said arms on said hub and spool assembly permit said axial movement of said spool relative to said hub and spool assembly prior to rotating said spool relative to said hub and spool assembly.
